(19) United States
(12) Patent Application Publication
(10) Pub. No.: US 2010/0052608 A1
(43) Pub. Date: Mar. 4, 2010

(54) ELECTRONIC APPARATUS

(75) Inventors: Yusuke Ota, Osaka (JP); Toshio Iwai, Osaka (JP); Yoshiharu Takemori, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/546,929

(22) Filed: Aug. 25, 2009

(30) Foreign Application Priority Data
Aug. 27, 2008 (JP) 2008-217694
Aug. 20, 2009 (JP) 2009-190556

(51) Int. Cl. H02J 7/00

(52) U.S. Cl. 320/106; 320/107; 320/150

(57) ABSTRACT

During charging of a battery, the start-up of the main body of an apparatus due to the switching on of a controller leads to increased consumption of power and also leads to heating of the battery, and therefore it is not possible to pass a sufficient charging current. A main microcomputer 5 serving as a main control apparatus, a charging IC 2 that performs charging of a battery 6, and a charging microcomputer 3 are provided. The charging microcomputer 3 monitors the operation of the main microcomputer 5, and the charging microcomputer 3 prohibits the charging operation by the charging IC 2 if the main microcomputer 5 is operating, and permits the charging operation by the charging IC 2 if the main microcomputer 5 is not operating.

### BACKGROUND OF THE INVENTION

1. Field of the Invention

The present invention relates to an electronic apparatus, such as a video camera, which uses a rechargeable cell.

2. Description of the Related Art

A rechargeable battery (rechargeable cell), such as a lithium ion (Li-ion) or a nickel hydrogen (Ni—H) battery, is used in the power supply of a portable electronic apparatus such as a mobile phone, a portable CD player and a digital still camera (DSC). In a conventional electronic apparatus of this kind, a main microcomputer, which controls the system of the apparatus main body, controls charging of power from an AC adapter to a rechargeable battery (hereinafter, called “battery”) via the apparatus main body. Japanese Patent Application Laid-Open Publication No. 2007-025260 relates to this technique.

Conventionally, in the electronic apparatus of this kind, the apparatus main body is started up due to the start-up of the main microcomputer, even during charging when the start-up of the apparatus main body is not necessary. Consequently, a portion of the power from the AC adapter is consumed by the apparatus main body, and the charging efficiency is reduced.

Furthermore, the start-up of the apparatus main body heats the battery, thereby promoting a temperature rise in the battery. In order to ensure safety, if the battery temperature reaches a certain predetermined temperature or above during charging, it is necessary to reduce the charging current and consequently there is a problem in that the charging time is extended.

### SUMMARY OF THE INVENTION

The present invention has been developed in order to solve the aforementioned problem, an object thereof being to provide an electronic apparatus in which it is possible to maximize the use of power from an AC adapter for charging a battery, without the power being consumed by the main body of the apparatus, as well as suppressing heating of the battery caused by the start-up of the main body, thus mitigating a temperature rise in the battery and making it possible to pass a large charging current.

The electronic apparatus according to the present invention comprises: a connector configured to be able to be connected electrically with the exterior in order to receive the supply of power; an installer configured to enable the installation of a rechargeable cell; a charger configured to charge a rechargeable cell installed in the installer, by using power supplied via the connector; a main controller configured to control the electronic apparatus; and a charging controller configured to monitor whether or not the main controller is operating, and in cases where the connector is connected to the exterior, to prohibit a charging operation by the charger if the main controller is operating, and to permit the charging operation by the charger if the main controller is not operating.

According to the present invention, by providing the charging controller that has a low power consumption and is specifically designed for controlling charging, separately from the main controller, and by permitting the charging operation by the charger if the main controller is not operating, a reduction in the consumption of power that does not contribute to the charging operation is achieved.

Furthermore, when the start-up of the main controller becomes necessary during charging, then the charging controller is able to switch the controller on and start up the main controller.

Furthermore, since the application of heat to the rechargeable cell due to the start-up of the electronic apparatus can be suppressed, then a temperature rise in the rechargeable cell is mitigated and it is possible to pass a large charging current.

### BRIEF DESCRIPTION OF THE DRAWINGS

FIG. 1 is a block diagram showing the configuration of a video camera which is an electronic apparatus relating to an embodiment of the present invention;

FIG. 2 is a flowchart showing the operation of setting, for instance, a charging current for a battery in a case where the battery is installed in the video camera which is the electronic apparatus relating to the present embodiment;

FIG. 3 is a sequence diagram showing a communications procedure when there has been an instruction for the start of charging of the video camera which is the electronic apparatus relating to the present embodiment; and

FIG. 4 is a flowchart showing operations of a charging microcomputer and a main microcomputer in the video camera which is the electronic apparatus relating to the present embodiment.

### DESCRIPTION OF THE PREFERRED EMBODIMENTS

Below, an embodiment of the present invention will be described with reference to the drawings.

### 1. Composition

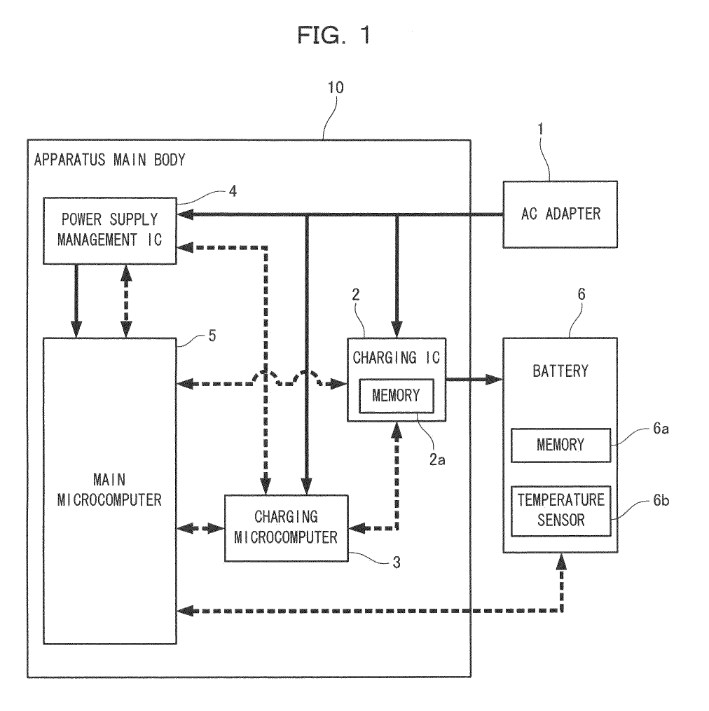

FIG. 1 is a block diagram showing the composition of a video camera which is an electronic apparatus relating to the embodiment of the present invention. In FIG. 1, an AC adapter 1 is attachable to and detachable from an apparatus main body 10 (a connected state is shown in FIG. 1) and supplies power to a video camera. A charging IC 2 charges a rechargeable battery 6 serving as a rechargeable cell (hereinafter called “battery 6”). A charging microcomputer 3 controls the on/off switching of the charging operation. A power supply management IC 4 controls the on/off of the operation of a main microcomputer 5. The main microcomputer 5 serving as the main controller controls the apparatus main body 10, which is the electronic apparatus. The battery 6 supplies power to the apparatus main body 10 by being connected to (installed in) the apparatus main body 10, and can be charged with power supplied from the AC adapter 1.

As shown in FIG. 1, the apparatus main body 10 comprises the charging IC 2 serving as a charger, the charging microcomputer 3 serving as charging controller, the power supply management IC 4 serving as a power supply management device, and the main microcomputer 5 serving as a main controller. The charging microcomputer 3 monitors whether or not the main microcomputer 5 is operating, and in cases where the AC adapter 1 is connected to the apparatus main body 10, prohibits the charging operation by the charging IC 2 if the main microcomputer 5 is operating, and permits the charging operation by the charging IC 2 if the main microcomputer 5 is not operating.

Furthermore, the main microcomputer 5 and the charging microcomputer 3 respectively have memories (storage units) (not illustrated), but memories (storage units) 2a and 6a also are provided respectively in the charging IC 2 and the battery 6. The charging IC 2 performs the charging operation in accordance with a current value and a voltage value recorded in the memory 2a, and the like. The rating capacity and the capacity (remaining capacity), and the like, are recorded in the memory 6a of the battery 6.

The battery 6 is installed in the main body 10 of the video camera, and a composition is adopted in which one type of battery 6 selected from batteries 6 of a plurality of types having different capacities is installed in the apparatus. For example, a composition is adopted whereby it is possible to install one type of battery 6 selected from a battery 6A of a capacity that enables the video camera to be used for one hour, a battery 6B of a capacity that enables the video camera to be used for two hours, and a battery 6C of a capacity that enables the video camera to be used for four hours. One battery cell is built into the battery 6A, whereas two battery cells connected in parallel are built into the battery 6B and four battery cells connected in parallel are built into the battery 6C. Furthermore, the connecting section (connection terminal) between the apparatus main body 10 and the battery 6 (6A to 6C) is standardized. For example, the battery 6B is substantially twice the size of the battery 6A and the battery 6C is substantially four times the size of the battery 6A, a portion of the battery 6 being exposed outside the apparatus main body 10 when installed. The composition is not limited to this, and it is also possible to adopt the casing of the battery 6C having the maximum capacity as a standard for the batteries 6A and 6B, and to accommodate the same inside the apparatus main body 10.

A temperature sensor 6b is provided in the battery 6, and at a low temperature the battery 6 is charged using a low amperage, while at a high temperature, the voltage is restricted so as to improve safety.

### 2. Operation

### 2-1. Operation of Setting Charging Current, Etc.

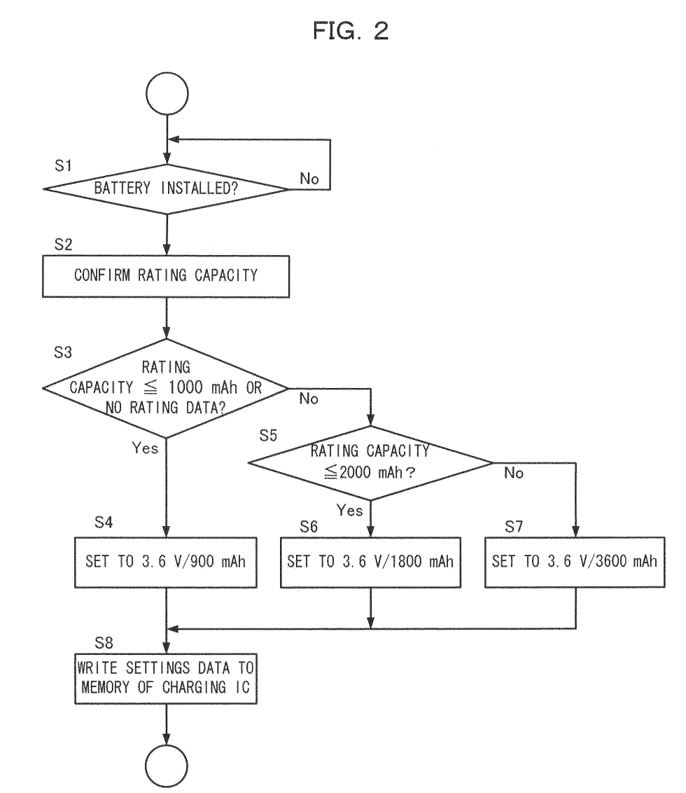

Next, the operation of setting up a charging current and the like, supplied to the battery 6, which is carried out before starting to charge the battery 6 when the battery 6 is installed in the video camera relating to the present embodiment, will be described on the basis of the flowchart shown in FIG. 2.

As shown in FIG. 2, the video camera relating to the present embodiment starts up the main microcomputer 5 if a change in voltage or current, or the like, is detected due to the battery 6 being installed in the apparatus main body 10. Upon starting up, at step S1, the main microcomputer 5 confirms that the battery 6 is installed in the apparatus main body 10. When the installation of the battery 6 has been confirmed, the main microcomputer 5 proceeds from step S1 to step S2 and reads in data about the rating capacity of the battery 6 stored in the memory 6a of the battery 6.

Next, the main microcomputer 5 proceeds from step S2 to step S3 and onwards, to set a charging voltage value (V) and a current value (mAh) corresponding to the rating capacity of the battery 6. In other words, basically, if the rating capacity of the battery 6 is 1000 mAh or lower, or if there is no rating capacity data (for example, in the case of the battery 6A), then the main microcomputer 5 proceeds from step S3 to step S4 and sets a low charging current value Ia (steps S2, S3). Furthermore, if the rating capacity of the battery 6 is greater than 1000 mAh and equal to or lower than 2000 mAh (for example, in the case of the battery 6B), the procedure advances from steps S3 and S5 to step S6, and the main microcomputer 5 sets a charging current value Ib that is higher than the charging current value Ia (for example, a charging current value that is twice the charging current value Ia). Moreover, if the rating capacity of the battery 6 is greater than 2000 mAh (for example, in the case of the battery 6C), the procedure advances from step S5 to step S7, and the main microcomputer 5 sets a charging current value Ic that is higher than the charging current value Ib (for example, a charging current value that is four times the charging current value Ia). Thereupon, at step S8, the main microcomputer 5 writes these set values to the memory 2a of the charging IC 2. The values are not limited to the current values and voltage values indicated in steps S4, S6 and S7 in FIG. 2.

By automatically setting charging conditions in accordance with the rating capacity of the battery 6 in this way, it is possible to charge the batteries 6B and 6C, each having a large rating capacity, safely and rapidly (in the case of the examples described above, in approximately the same time as the battery 6A having a small rating capacity). In other words, when a uniform charging current value is adopted at all times even in a case where the batteries 6 having different rating capacities (6A to 6C) are installed, a small charging current value inevitably is set in such a manner that even the battery 6A having a small rating capacity can be charged safely, and therefore when the batteries 6B, 6C each having a large rating capacity are installed, the charging time becomes long (for example, if the charging time for the battery 6A is approximately one hour, then the charging time for the battery 6B is approximately two hours and the charging time for the battery 6C is approximately four hours), and hence usability declines. As opposed to this, by using the method described above, it is possible to eliminate the decline in usability and to charge a battery 6 of any rating capacity safely and rapidly.

However, the setting method described above is a basic setting method when the battery 6 is in a normal temperature state, and in the video camera relating to the present embodiment, depending on the temperature of the battery 6, charging is performed at low amperage when the temperature is low, whereas the charging voltage is restricted when the temperature is high, thereby improving safety and the like. More specifically, in a normal temperature state (10° C. to 45° C.), for example, full charging (100%) is possible, whereas in a low temperature state (lower than 10° C.), the charging current value is set lower by a predetermined ratio than the basic setting. Furthermore, in a relatively high temperature state (45° C. to 50° C.), the charging current value is the same, but the voltage at full charge is set lower (the voltage in a case where the capacity of the battery 6 is approximately 95% of the fully charged state), and in a high temperature state (50° C. to 60° C.), the maximum charging current value is the same, but the voltage at full charge is set yet lower (the voltage in a case where the capacity of the battery 6 is approximately 90% of the fully charged state). In an even higher temperature state (exceeding 60° C.), charging is halted. Consequently, it is possible to carry out charging safely at all times.

### 2-2. Operation of Transferring to Charging Mode

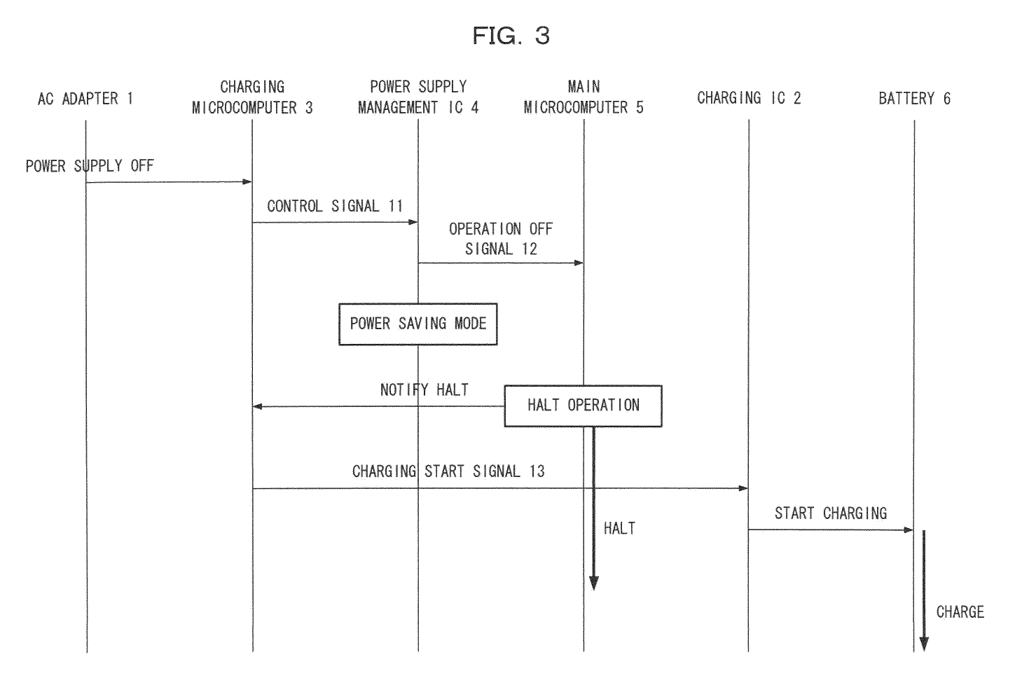

Next, the operation of the video camera relating to the present embodiment when transferring from a normal operation mode to a charging mode will be described. FIG. 3 is a sequence diagram showing a communications procedure when transferring to the charging mode, by shifting from a state where the power supply of the video camera is on and the AC adapter 1 is connected to a state where the power supply of the video camera is off. The video camera relating to the present embodiment performs charging of the battery 6 only when the power supply is off and the AC adapter 1 is connected. In other words, even if the AC adapter 1 is connected, when the power supply of the video camera is on, then charging of the battery 6 is not carried out.

As shown in FIG. 3, if the power supply is switched off from the state where the power of the video camera is on and the AC adapter 1 is attached to the video camera 10, then in order to transfer from the normal operation mode to the charging mode, the charging microcomputer 3 that controls charging sends a control signal 11 to the power supply management IC 4 which manages the power supply. When the power supply management IC 4 receives the control signal 11, it sends an operation off signal 12 to the main microcomputer 5 that controls the apparatus main body 10. The main microcomputer 5 receives the off signal, notifies the charging microcomputer 3 that the operation of the main microcomputer 5 is to be halted (a composition may also be adopted whereby the charging microcomputer 3 is able to detect that the operation of the main microcomputer 5 has halted), and then halts the operation. In other words, the operation of the apparatus main body 10 is halted at this point.

In this embodiment, in a parallel fashion, when the power supply management IC 4 receives the control signal, the power supply management IC 4 itself transfers to a power saving operation mode. The power supply management IC 4 has two modes: a normal operation mode and a power saving operation mode; and in the power saving operation mode, for example, the power supply management IC 4 only performs minimal functions, for instance, by halting all functions other than a timer function. In this way, in the present embodiment, the consumption of power in the operation of the apparatus main body 5 is minimized by halting the operation of the main microcomputer 5 (in other words, halting the operation of the apparatus main body 10) and changing the power supply management IC 4 to the power saving operation mode.

Upon detecting that the main microcomputer 5 (apparatus main body 10) has halted the operation, the charging microcomputer 3 sends a charging start signal 13 to the charging IC 2 which performs charging of the battery 6. The charging IC 2 receives the charging start signal 13 and starts the charging of the battery 6. Unless there is a need to start up the apparatus main body 10, charging continues and when a fully charged state is detected by the charging IC 2 or the charging microcomputer 3, charging is terminated.

Here, a case has been described where the power supply of the video camera is initially in an on state, but if the power supply of the video camera is initially in an off state, then it is also possible for the charging microcomputer 3 to send the charging start signal 13 instantaneously to the charging IC 2 whenever the AC adapter 1 is connected to the video camera, rather than sending the control signal 11. Furthermore, if the power supply of the video camera is initially in an off state, then it is also possible for the charging microcomputer 3 to switch the main microcomputer 5 on temporarily when the AC adapter is connected to the video camera, and then to send the charging start signal 13 to the charging IC 2 when the main microcomputer 5 subsequently is switched off.

Furthermore, when it becomes necessary to start up the apparatus main body 10 during charging, then the charging microcomputer 3 sends a charging halt signal to the charging IC 2. When the charging IC 2 receives the charging halt signal and halts charging, the charging microcomputer 3 sends the control signal to the power supply management IC 4. The power supply management IC 4 receives the control signal and transfers to the normal operation mode. After having transferred to the normal operation mode, the power supply management IC 4 sends an operation on signal to the main microcomputer 5. Upon receiving the operation on signal and switching on, the main microcomputer 5 starts the control of the apparatus main body 10. In other words, the operation of the apparatus main body 10 is started at this point.

As an example where the start-up of the apparatus main body 10 becomes necessary during charging, the main microcomputer 5 is started up in order to write to the memory 6a of the battery 6 the current capacity of the battery 6 produced by charging from the start of charging until the present time as measured by the charging microcomputer 3.

### 2-3. Charging Operation

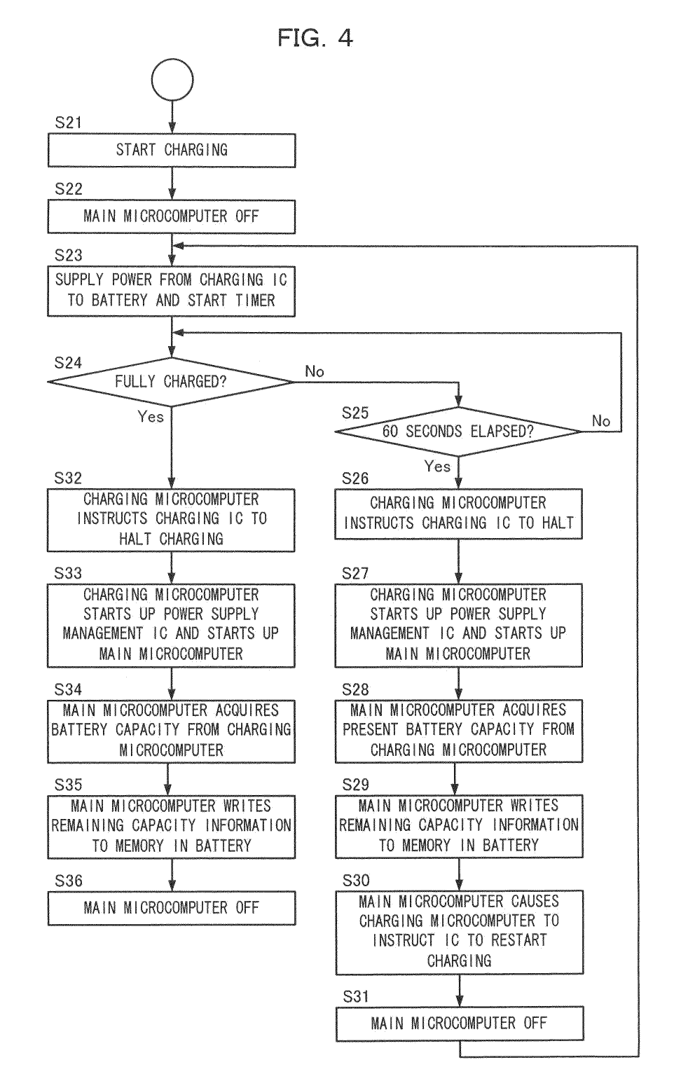

The operations of the charging microcomputer 3 and the main microcomputer 5 during the charging of the battery 6 are described here on the basis of the flowchart shown in FIG. 4. If there is an instruction for starting charging (step S21), according to the operation described above, the main microcomputer 5 is switched to an off state (step S22), and power is supplied to the battery 6 by the charging IC 2. Furthermore, at this point, the charging microcomputer 3 switches on a timer provided inside the charging microcomputer 3 (step S23) in order to set the start up timing of the main microcomputer 5, and then proceeds to the next steps S24 and S25. In a case where a prescribed time period has elapsed while the battery 6 is not in a fully charged state, it proceeds to step S26.

In other words, if the aforementioned prescribed time period has elapsed with the battery 6 not in a fully charged state, then the charging microcomputer 3 instructs the charging IC 2 to halt charging (step S26), and in accordance with this, the charging microcomputer 3 starts up the power supply management IC 4 and causes the main microcomputer 5 to start up (step S27). The charging microcomputer 3 has a current value detection circuit that detects the current value supplied to the battery 6 from the charging IC2 during charging, and thereby can ascertain how much the battery is charged. The main microcomputer 5 acquires the present capacity of the battery 6 as ascertained by the charging microcomputer 3 (in other words, the capacity value resulting from the capacity before charging of the battery 6 plus the charged capacity based on the product of the charging voltage, the charging current and the charging time) (step S28). The main microcomputer 5 writes information about the capacity to the memory 6a of the battery 6 (step S29). Thereupon, the main microcomputer 5 causes the charging microcomputer 3 to instruct the charging IC 2 to restart charging (step S30), and then the main microcomputer 5 itself is switched off (step S31).

At step S24, if the fully charged state of the battery 6 is detected, then the procedure advances to step S32, and the charging microcomputer 3 instructs the charging IC 2 to halt charging. In so doing, the charging microcomputer 3 starts up the main microcomputer 5 via the power supply management IC 4 (step S33), the main microcomputer 5 acquires the present capacity of the battery 6 as ascertained by the charging microcomputer 3 (step S34), and the main microcomputer 5 writes the information about the capacity to the memory 6a of the battery 6 (step S35). Thereupon, the main microcomputer 5 switches itself off (step S36).

In this way, by writing the capacity resulting from charging to the memory 6a in the battery 6 and continuously updating the capacity of the battery 6, either during charging or after the termination of charging, then even if the battery 6 is removed at any timing, the most recent capacity can be held in the memory 6a of the battery 6.

If the battery 6 is not in a normal temperature state during charging, then as described above, this is corrected either by setting the charging current value lower by the predetermined ratio than the basic setting when in a low temperature state (less than 10° C.), or by charging with a low full charge voltage set when in a high temperature state, for safety purposes, and the main microcomputer 5 writes a value corresponding to the actual state of charging (a value corrected in accordance with the temperature) as the present capacity, to the memory 6a of the battery 6. By this means, even if the temperature of the battery 6 varies, it is still possible to write an accurate value to the memory 6a of the battery 6.

As described above, according to the present embodiment, if charging of the battery 6 is carried out by providing the charging microcomputer 3 serving as a charging controller that is designed specifically for controlling charging, separately from the main microcomputer 5 serving as a controller for controlling the main body 10 of the apparatus, it is possible to reduce power consumption that does not contribute to the charging operation, by switching off the current passing through the main microcomputer 5 and virtually halting the operation of the apparatus main body 10 including the main microcomputer 5. Furthermore, as a result of this, since application of heat to the battery 6 is restricted, then measures for reducing the charging current due to heating become unnecessary, and therefore problems such as extended charging time do not occur.

Furthermore, according to the composition described above, in cases where it is possible to install batteries 6 of a plurality of types having different capacities, then even a battery 6 of a large capacity can be charged safely and rapidly. Moreover, in the present embodiment, since the power consumption that does not contribute to the charging operation can be reduced and the charging current can be increased by a corresponding amount, then it is advantageously possible to charge even a battery 6 having a large capacity without maintaining or substantially raising the rating of the AC adapter 1.

Furthermore, according to the composition described above, even in cases where it becomes necessary to start up the apparatus main body 10 during charging, it is possible to switch the main microcomputer 5 on by means of the charging microcomputer 3 and thereby to start up the apparatus main body 10. Consequently, as described above, it is possible to store nearly the most up-to-date capacity information indicating the charged state in the memory 6a of the battery 6. Furthermore, even if the temperature of the battery 6 varies during charging, it is still possible to write an accurate value to the memory 6a of the battery 6, and therefore the reliability is improved.

Furthermore, in the embodiment described above, the power supply management IC 4 is provided separately from the main microcomputer 5, but the invention is not limited to this and as a further embodiment, the power supply management IC 4 also can be composed as a portion of the main microcomputer 5, if it is possible to achieve power reduction whereby the power consumption in the power saving operation mode of the main microcomputer 5 is of a tolerable level for a portable type electronic apparatus which is driven by the battery 6.

Moreover, in the embodiment described above, the charging microcomputer 3 monitors whether or not the power supply of the video camera has been switched off, and if the power supply of the video camera is switched off, then the charging microcomputer 3 sends the control signal 11 to the power supply management IC 4, whereupon the power supply management IC 4 sends the operation off signal 12 to the main microcomputer 5. However, the invention is not necessarily limited to a composition of this kind. For example, it is also possible to adopt a composition whereby rather than the charging microcomputer 3 monitoring the switching off of the power supply of the video camera, the power supply management IC 4 monitors the switching off of the power supply of the video camera and sends the operation off signal 12 to the main microcomputer 5 when the power supply of the video camera is switched off.

The present invention is not limited to a video camera and can also be applied to general portable electronic apparatuses and the like, which use a battery.

The electronic apparatus according to the present invention is extremely useful as a system composition for achieving maximum possible use of power supplied by an AC adapter and shortening charging time, and therefore is not limited to a video camera, but rather can be applied to portable or other electronic apparatuses in general which perform charging of an apparatus main body.

What is claimed is:

1. An electronic apparatus, comprising:
a connector configured to be able to be electrically connected with an exterior in order to receive supply of power;
an installer configured to enable installation of a rechargeable cell;
a charger configured to charge a rechargeable cell installed in the installer, by using power supplied via the connector;
a main controller configured to control the electronic apparatus; and
charging controller configured to monitor whether or not the main controller is operating, and in cases where the connector is connected to the exterior, to prohibit a charging operation by the charger if the main controller is operating, and to permit the charging operation by the charger if the main controller is not operating.

2. The electronic apparatus according to claim 1, wherein the charging controller also monitors whether or not the connector is connected to the exterior, and starts the charging operation by the charger if it is confirmed that the connector is connected to the exterior and that the main controller is not operating.

3. The electronic apparatus according to claim 1, wherein rechargeable cells of a plurality of types having different rating capacities can be installed in the installer,
the electronic apparatus further comprises a type detector for detecting the type of the rechargeable cell installed in the installer, and
the charger charges the rechargeable cell with power corresponding to the rating capacity of the rechargeable cell of the type detected by the type detector.

4. The electronic apparatus according to claim 1, wherein when it becomes necessary to start up the main controller in order to carry out prescribed processing periodically during charging, upon detecting elapse of a prescribed time period using a timer provided in the charging controller, the charging controller switches off supply of current to the charger, as well as switching on supply of current to the main controller, to start control of the electronic apparatus and cause the prescribed processing to be carried out, whereupon the charging controller switches on the supply of current to the charger and switches off the supply of current to the main controller.

5. The electronic apparatus according to claim 4, wherein a memory having a region for storing a capacity of the rechargeable cell is provided in the rechargeable cell, and upon detecting the elapse of the prescribed time period during charging using the timer provided in the charging controller, the charging controller switches off the supply of current to the charger, as well as switching on the supply of current to the main controller to implement a process for writing the capacity to the memory of the rechargeable cell, whereupon the charging controller switches on the supply of current to the charger and switches off the supply of current to the main controller.

6. The electronic apparatus according to claim 5, wherein the main controller corrects an amount of charge of the rechargeable cell on a basis of temperature information of the rechargeable cell and implements a process for writing a capacity corresponding to a corrected value to the memory of the rechargeable cell.

7. The electronic apparatus according to claim 1, wherein the electronic apparatus is a video camera.
